(19) United States
(12) Patent Application Publication
(10) Pub. No.: US 2014/0269901 A1
(43) Pub. Date: Sep. 18, 2014

(54) METHOD AND APPARATUS FOR PERCEPTUAL MACROBLOCK QUANTIZATION PARAMETER DECISION TO IMPROVE SUBJECTIVE VISUAL QUALITY OF A VIDEO SIGNAL

(71) Applicant: MAGNUM SEMICONDUCTOR, INC., Milpitas, CA (US)

(72) Inventor: Xun Shi, Toronto (CA)

(73) Assignee: Magnum Semiconductor, Inc., Milpitas, CA (US)

(21) Appl. No.: 13/800,804

(22) Filed: Mar. 13, 2013

(51) Int. Cl. H04N 7/26

(52) U.S. Cl. CPC H04N 19/00096
USPC 375/240.03

(57) ABSTRACT

Examples of methods and apparatuses for improving subjective video quality of a video signal are described herein. An example apparatus may include an encoder. The encoder may be configured to receive a video signal and to generate a saliency score for a macroblock of the video signal. The encoder may further be configured to adjust a quantization parameter for the macroblock of the video signal based, at least in part, on the respective saliency score for the macroblock of the video signal.

### TECHNICAL FIELD

Embodiments of this invention relate generally to video encoding, and more specifically, to the quantization of transform coefficients.

### BACKGROUND

Video or other media signals, may be used by a variety of devices, including televisions, broadcast systems, mobile devices, and both laptop and desktop computers. Typically, devices may display video in response to receipt of video or other media signals, often after decoding the signal from an encoded form. Video signals provided between devices are often encoded using one or more of a variety of encoding and/or compression techniques, and video signals are typically encoded in a manner to be decoded in accordance with a particular standard, such as MPEG-2, MPEG-4, and H.264/MPEG-4 Part 10. By encoding video or other media signals, then decoding the received signals, the amount of data provided between devices may be significantly reduced.

Video encoding typically proceeds by encoding macroblocks, or other units, of video data. Prediction coding may be used to generate predictive blocks and residual blocks, where the residual blocks represent a difference between a predictive block and the block being coded. Prediction coding may include spatial and/or temporal predictions to remove redundant data in video signals, thereby further increasing the reduction of data. Intracoding for example, is directed to spatial prediction and reducing the amount of spatial redundancy between blocks in a frame or slice. Intercoding, on the other hand, is directed toward temporal prediction and reducing the amount of temporal redundancy between blocks in successive frames or slices. Intercoding may make use of motion prediction to track movement between corresponding blocks of successive frames or slices.

Typically, in encoder implementations, including intracoding and intercoding based implementations, residual blocks (e.g., difference between actual and predicted blocks) may be transformed, quantized, and encoded using one of a variety of encoding techniques (e.g., entropy encoding) to generate a set of coefficients. It is these coefficients that may be transmitted between the encoding device and the decoding device. Quantization may be determinative of the amount of loss that may occur during the encoding of a video stream. That is, the amount of data that is removed from a bitstream may be dependent on a quantization parameter generated by and/or provided to an encoder.

Existing approaches to determine optimal coding parameters (e.g. the quantization parameter) are often based on objective evaluation criteria, such as rate-distortion optimization. However, in many cases, these objective evaluation criteria are not consistent with subjective experience, and techniques using objective evaluation criteria may not always lead to optimal subjective visual quality. One approach to evaluate subjective coded video quality includes comparing compressed video clips encoded using two different coding techniques based on a same video source. In this manner, human subjects can distinguish based on observable visual difference to determine the better coding technique.

Many current approaches to quantization adjust a quantization parameter for improved subjective visual quality using single image statistics, such as macroblock activity However, these approaches often lead coded results towards specific image patterns and do not constitute a general process for improving visual quality that is consistent with human visual perception. Other existing approaches employ a concatenation of multiple quantization parameter adjustments based on multiple image statistics. However, decisions made at each adjustment process may contradict one another, and the results may not always lead to consistent coded quality. Moreover, while some approaches may rely on image filtering methodologies, these approaches are relatively complex and computationally demanding. As a result, image filtering methodologies may, for many current coding standards, simply be too demanding for implementation in real-time.

### BRIEF DESCRIPTION OF THE DRAWINGS

FIG. 1 is a block diagram of an encoder according to an embodiment of the present invention.

FIG. 2 is a block diagram of an encoder according to an embodiment of the present invention.

FIG. 3 is a block diagram of a quantization parameter controller according to an embodiment of the present invention.

FIG. 4 is a block diagram of a saliency detection block according to an embodiment of the present invention.

FIG. 5 is a flowchart of a method for adjusting a quantization parameter according to an embodiment of the present invention.

FIG. 6 is a schematic illustration of a media delivery system according to an embodiment of the invention.

FIG. 7 is a schematic illustration of a video distribution system that may make use of encoders described herein.

### DETAILED DESCRIPTION

Examples of methods and apparatuses for improving video quality of a video signal are described herein. In accordance with one or more described embodiments, quantization parameters of macroblocks of a video signal may be adjusted in accordance with respective saliency scores. Certain details are set forth below to provide a sufficient understanding of embodiments of the invention. However, it will be clear to one having skill in the art that embodiments of the invention may be practiced without these particular details, or with additional or different details. Moreover, the particular embodiments of the present invention described herein are provided by way of example and should not be used to limit the scope of the invention to these particular embodiments. In other instances, well-known video components, encoder or decoder components, circuits, control signals, timing protocols, and software operations have not been shown in detail in order to avoid unnecessarily obscuring the invention.

FIG. 1 is a block diagram of an encoder 100 according to an embodiment of the invention. The encoder 100 may include one or more logic circuits, control logic, logic gates, processors, memory, and/or any combination or sub-combination of the same, and may be configured to encode and/or compress a video signal using one or more encoding techniques, examples of which will be described further below. The encoder 100 may be configured to encode, for example, a variable bit rate signal and/or a constant bit rate signal, and generally may operate at a fixed rate to output a bitstream that may be generated in a rate-independent manner. The encoder 100 may be implemented in any of a variety of devices employing video encoding, including, but not limited to, televisions, broadcast systems, mobile devices, and both laptop and desktop computers. In at least one embodiment, the encoder 100 may include an entropy encoder, such as a variable-length coding encoder (e.g., Huffman encoder or CAVLC encoder), and/or may be configured to encode data, for instance, at a macroblock level. Each macroblock may be encoded in intra-coded mode, inter-coded mode, bidirectionally, or in any combination or subcombination of the same.

By way of example, the encoder 100 may receive and encode a video signal comprising a plurality of sequentially ordered coding units (e.g., block, macroblock, slice, frame, field, group of pictures, sequence). The video signal may be encoded in accordance with one or more encoding standards, such as MPEG-2, MPEG-4, H.263, H.264, H.265, and/or HEVC, to provide an encoded bitstream. The encoded bitstream may in turn be provided to a data bus and/or to a device, such as a decoder or transcoder (not shown in FIG. 1).

A video signal may be encoded by the encoder 100 such that video quality (e.g., subjective video quality) of the video signal is improved. Video quality may, for example, be improved by adjusting a quantization parameter of a macroblock based, at least in part, on a perceptual measurement of one or more video content elements (e.g., statistics or features) included in the macroblock. In some instances, statistics may refer to statistical values of an image or a sub-region of an image, for example, averaged pixel value, min/max pixel values, pixel variations, etc. Features may refer to representations of image structure and/or pixel relationships, such as edge, curvature, corner, etc. Moreover, a saliency representation may be determined based on these video content elements, which may be used to estimate a relative importance of regions within a given image of video, or to estimate likely human fixations. A saliency representation typically may comprise a two-dimensional intensity map that covers a same spatial scope as an input image, and thus may be referred to as a saliency map. Given a saliency map, high intensity values (saliency score) may indicate salient (important) regions or regions more likely to attract human fixation.

In at least one embodiment, perceptual measurement of video content elements may comprise identification of perceptually salient regions of a video signal. Perceptual salience of these regions may, for instance, be quantified using a salience score. As will be explained in further detail below, during an encoding process, each macroblock of a picture may be assigned a salience score and the quantization parameter associated with the macroblock may be adjusted in accordance with the salience score. In this manner, a salience score may operate as an adjustment index for a quantization parameter of a corresponding macroblock. In at least one embodiment, a high saliency score may result in a decreased quantization parameter and as a result, a higher bit rate. Similarly, a low saliency score may result in an increased quantization parameter and as a result, a lower bit rate. In some embodiments, quantization parameters may be adjusted (e.g., bits reallocated) between macroblocks of a same picture such that subjective visual quality is improved while a bit rate of the video signal is maintained. In other embodiments, bits may be reallocated at other coding unit levels, such as at a frame level, such that subjective visual quality is improved while a bit rate of the video signal is maintained.

FIG. 2 is a block diagram of an encoder 200 according to an embodiment of the present invention. The encoder 200 may be used to implement, at least in part, the encoder 100 of FIG. 1, and may further be compliant with one or more coding standards, such as MPEG-2, H.264, and H.265 coding standards.

The encoder 200 may include a mode decision block 230, a prediction block 220, a delay buffer 202, a transform 206, a quantization block 222, an entropy encoder 208, an inverse quantization block 210, an inverse transform block 212, an adder 214, a deblocking filter 216, and a decoded picture buffer 218. The mode decision block 230 may be configured to determine an appropriate coding mode based, at least in part, on the incoming video signal and a decoded picture buffer signal and/or may determine an appropriate coding mode on a per frame and/or macroblock basis. The mode decision may include macroblock type, intra modes, inter modes, syntax elements (e.g., motion vectors), and/or one or more quantization parameters. As will be explained in more detail below, the mode decision block 230 may include a quantization parameter (QP) controller 250 that may provide an adjusted quantization parameter mbQP′ for use by the quantization block 222. The quantization block 222 may quantize one or more coefficients of a coefficient block based, at least in part, on the adjusted quantization parameter mbQP′.

The output of the mode decision block 230 may be utilized by the prediction block 220 to generate a predictor in accordance with one or more coding standards (e.g., MPEG-2) and/or other prediction methodologies. The predictor may be subtracted from a delayed version of the video signal at the subtractor 204. Using the delayed version of the video signal may provide time for the mode decision block 230 to act. The output of the subtractor 204 may be a residual, e.g. the difference between a block and a prediction for a block.

The transform 206 may be configured to perform a transform, such as a discrete cosine transform (DCT), on the residual to transform the residual to the frequency domain. As a result, the transform 206 may provide a coefficient block that may, for instance, correspond to spectral components of data in the video signal. For example, the coefficient block may include a DC coefficient corresponding to a zero frequency component of the coefficient block that may, for instance, correspond to an average value of the coefficient block. The coefficient block may further include a plurality of AC coefficients corresponding to higher (non-zero) frequency portions of the coefficient block.

The quantization block 222 may be configured to receive the coefficient block and quantize the coefficients (e.g., DC coefficient and AC coefficients) of the coefficient block to produce a quantized coefficient block. The quantization provided by the quantization block 222 may be lossy and/or may also utilize one or more quantization parameters, such as an adjusted quantization parameter mbQP′, to employ a particular degree of quantization for one or more coefficients of the coefficient block. As known, a quantization parameter may determine the amount of spatial detail that is preserved during a respective quantization process. In some embodiments, mbQP′ may be received from the QP controller 250 of the mode decision block 230, may be specified by a user, or may be provided by another element of the encoder 200. Additionally or alternatively, mbQP′ may be adjusted for each macroblock, and/or may be based on information encoded by the encoder 200. By way of example, macroblocks associated with higher activity (e.g., greater pixel value variation) in one or more components may generally be associated with a smaller QP.

In turn, the entropy encoder 208 may encode the quantized coefficient block to provide an encoded bitstream. The entropy encoder 208 may be any entropy encoder known by those having ordinary skill in the art or hereafter developed, such as a variable length coding (VLC) encoder or a context-adaptive binary arithmetic coding (CABAC) encoder. The quantized coefficient block may also be inverse-quantized by the inverse quantization block 210. The inverse-quantized coefficients may be inverse transformed by the inverse transform block 212 to produce a reconstructed residual, which may be added to the predictor at the adder 214 to produce reconstructed video. The reconstructed video may be provided to the decoded picture buffer 218 for use in future frames, and further may be provided from the decoded picture buffer 218 to the mode decision block 230 for further in-macroblock intra prediction or other mode decision methodologies.

As described, the QP controller 250 may provide an adjusted quantization parameter mbQP′ to the quantization block 222. In at least one embodiment, mpQP′ may be based, at least in part, on the incoming video signal, and in particular, on one or more video content elements of the video signal. Video content elements may include, but are not limited to, luminance component activity, chrominance component activity (for each chrominance component or for both), a sum of absolute differences between successive macroblocks (e.g., previous and current macroblocks), luminance component mean value, chrominance component mean value (for each chrominance component or both chrominance components), and/or skin tone strength.

In operation, the QP controller 250 may identify perceptually salient regions of the video signal to assign saliency scores to each macroblock of the video signal. The quantization parameter for each macroblock may be adjusted based on a respective saliency score. As described, a relatively high saliency score may generally result in a lower quantization parameter such that the number of bits allocated to the corresponding macroblock is increased. A relatively low saliency score may generally result in a higher quantization parameter such that the number of bits allocated to the corresponding macroblock is increased. In at least one embodiment, quantization parameters may be adjusted such that the total bit rate of the video signal is maintained. Maintaining the bit rate in this manner may, for instance, rely on operation of a closed loop controller (not shown).

The encoder 200 may operate in accordance with one or more video coding standards, such as H.264. Thus, because the H.264 coding standard, in addition to other video coding standards, employ motion prediction and/or compensation, the encoder 200 may further include a feedback loop having an inverse quantization block 210, an inverse transform 212, and a reconstruction adder 214 and a deblocking filter 216. These elements may mirror elements included in a decoder (not shown) that is configured to reverse, at least in part, the encoding process performed by the encoder 200. Additionally, the feedback loop of the encoder may include a prediction block 220 and a decoded picture buffer 218.

In an example operation of the encoder 200, a video signal (e.g. a base band video signal) may be provided to the encoder 200. The video signal may be provided to the delay buffer 202 and the mode decision block 230. The subtractor 204 may receive the video signal from the delay buffer 202 and may subtract a motion prediction signal from the video signal to generate a residual signal. The residual signal may be provided to the transform 206 and processed using a forward transform, such as a DCT. As described, the transform 206 may generate a coefficient block that may be provided to the quantization block 222, and the quantization block 222 may quantize and/or optimize the coefficient block. Quantization of the coefficient block may be based, at least in part, on a quantization parameter mbQP′, and quantized coefficients may be provided to the entropy encoder 208 and thereby encoded into an encoded bitstream.

The quantized coefficient block may further be provided to the feedback loop of the encoder 200. That is, the quantized coefficient block may be inverse quantized and inverse transformed by the inverse quantization block 210 and the inverse transform 212, respectively, to produce a reconstructed residual. The reconstructed residual may be added to the predictor at the adder 214 to produce reconstructed video, which may be deblocked by the deblocking filter 216, written to the decoded picture buffer 218 for use in future frames, and fed back to the mode decision block 230 and the prediction block 220. Based, at least in part, on the reconstructed video signals, the prediction block 220 may provide a motion prediction signal to the adder 204.

Accordingly, the encoder 200 of FIG. 2 may provide a coded bitstream based on a video signal, where the coded bitstream is generated in part using a quantization parameter mbQP′ provided in accordance with embodiments of the present invention. The encoder 200 may be operated in semiconductor technology, and may be implemented in hardware, software, or combinations thereof. In some examples, the encoder 200 may be implemented in hardware with the exception of the mode decision block 230 that may be implemented in software. In other examples, other blocks may also be implemented in software, however software implementations in some cases may not achieve real-time operation. Moreover, in some examples, components of the encoder 200 may be combined or separated. The QP controller 250 may, for instance, be located outside and operate independent of the mode decision 230.

FIG. 3 is a block diagram of a quantization parameter (QP) controller 300 according to an embodiment of the present invention. The QP controller 300 may be used to implement, at least in part, the QP controller 250 of FIG. 2. The QP controller 300 may be implemented in semiconductor technology, and may be implemented in hardware, software, or combinations thereof.

The QP controller 300 may include a saliency detection block 302 and a QP adjustment block 304. The saliency detection block 302 may be configured to receive an incoming video signal and provide (e.g., generate) a saliency map based, at least in part, on each of a plurality of video content elements of the video signal. Each index of the saliency map may comprise a saliency score of a macroblock. Moreover, the saliency map may comprise a combination of histogram counts of the plurality of video content elements, and in one embodiment, the saliency map may comprise a weighted combination of histogram counts.

The QP adjustment block 304 may be coupled to the QP controller and configured to receive the saliency map from the QP adjustment block 302 and an initial quantization parameter mbQP. The QP adjustment block 304 may be configured to use the saliency map to determine a saliency score for a macroblock and adjust the initial quantization parameter mbQP in accordance with the saliency score to provide the adjusted quantization parameter mpQP′. In some embodiments, the initial quantization parameter mbQP may be based, at least in part, on the video signal, may be provided by a user, and/or may be a default value provided during initialization of the encoder 200. In at least one embodiment, the initial quantization parameter may be based, at least in part, on an estimated picture (e.g., frame or field) size. As described, the adjusted quantization parameter mbQP′ may be provided to one or more components of the encoder 200 of FIG. 2, including the quantization block 250.

FIG. 4 is a block diagram of a saliency detection block 400 according to an embodiment of the present invention. The saliency detection block may be used to implement, at least in part, the saliency detection block 302 of FIG. 3. While operation of the saliency detection block 400 is described with respect to macroblocks, it will be appreciated that operating of the saliency detection block 400 may be directed to any coding unit level. The saliency detection block 400 may be implemented in semiconductor technology, and may be implemented in hardware, software, or combinations thereof.

The saliency detection block 400 may be configured to receive a video signal and provide a saliency map based on a plurality of identified video content elements of the video signal. Generally, the saliency detection block 400 may operate to identify (e.g., extract) a plurality of video content elements in a video signal. Video content elements may comprise any statistic or feature abstracted from the video signal. For example, video content elements may include, but are not limited to, luminance component activity, chrominance component activity, a sum of absolute differences between successive macroblock, luminance component mean value, chrominance component mean value, and/or skin tone strength.

Identifying a video content element may include determining a magnitude of a particular video content element included in a macroblock. Video content elements may be identified from different perspectives, including but not limited to, edges, curvatures, shapes, luminance mean values, chrominance mean values, and pixel variance. In identifying video content elements, the saliency detection block 400 may provide (e.g., generate) a feature map for each video content element. Each feature map may be a two-dimensional representation (e.g., a two-dimensional array) of the magnitude of a video content element in each macroblock of a picture. Each feature map may subsequently be used to provide a respective histogram, which may in turn be used to provide a respective count map. The saliency detection block 400 may provide a saliency map based, at least in part, on the plurality of feature count maps.

An example operation of the saliency detection block 400 is described herein. Operation is described with respect to a video content element, however, it will be appreciated by those having ordinary skill in the art that any number of video content elements may be considered by the saliency detection block simultaneously, sequentially and/or in an overlapping manner.

In an example operation of the saliency detection block 400, an identification block 402 may receive the video signal. The identification block 402 may be associated with a video content element and accordingly may be configured to identify a particular video content element in the video signal. For each picture (e.g., frame or field), the identification block 402 may identify a magnitude of the associated video coding element in each macroblock of the picture. In this manner, the identification block 402 may generate a feature map indicating the magnitude, or strength, of the video coding element for each respective macroblock in a two-dimensional representation.

Once the feature map has been generated, the identification block 402 may provide the feature map to the histogram generation block 404. The histogram generation block 404 may be configured to generate a histogram based, at least in part, on the feature map. The histogram may, for instance, include a plurality of bins, each having a value that is the count of a particular magnitude of the video content element in the feature map. For example, if a feature map is directed to activity of a luminance component and includes 6 macroblocks identified as having activity with a magnitude of 4, a bin associated with a magnitude of 4 may have a value of 6.

The histogram generation block 404 may provide the histogram and the feature map to a count block 406. The count block 406 may be configured to provide a count map based, at least in part, on the received histogram and the feature map. The count map may comprise a two-dimensional array having the same dimensions as the feature map. Each index of the count map may have a value equal to a bin of the histogram associated with the corresponding index of the feature map. For example, with reference to the aforementioned histogram example, those indices of the feature map identified as having activity with a magnitude of 4 may have a value of 6 in the count map (the number of macroblocks of the feature map having a magnitude of 4).

The count block 406 may provide the count map to an inverse block 408 and a weighting block 410, wherein each value of the count map may be inversed and subsequently weighted in accordance with a weighting parameter, respectively. In some embodiments, each video content element may use a same weighting parameter or may use a respective weighting parameter. Once inversed and weighted, the count map may be provided to a summer 412 to be combined with count maps for each of the other video content elements to provide a saliency map. For example, once each count map has been generated by a respective count block 406, each count map may be combined to provide a saliency map according to the following equation:

$$SMap ( i , j ) = {\sum }_{k} \frac{1}{{W}_{k} * CountMap ( i , j )}$$

where Wₖ represents a bias weighting parameter for a video content element W, k represents the number of video content elements identified by the saliency detection unit 400, and (i,j) represents an index of a respective coding unit (e.g., macroblock). In at least one embodiment, Wₖ=1 may be used for all video content elements.

As described, a saliency map may be used to determine a saliency score for adjusting a quantization parameter mbQP. FIG. 5 is a flowchart of a method 500 for adjusting a quantization parameter according to an embodiment of the present invention. The method may be implemented, for instance, using the QP adjustment block 304 of FIG. 3.

At step 505, an average saliency value for a saliency map may be determined. The average saliency value may be determined by totaling the saliency scores of the saliency map and dividing by the number of indices. For example, an average saliency value may be determined according to the following formula:

$$AveSaliency = \frac{1}{m * n} {\sum }_{i = 1}^{m} {\sum }_{j = 1}^{n} SMap ( i , j )$$

where m and n correspond to the number of columns and rows of macroblocks of a picture, respectively. At step 510, an adjusted quantization parameter may be determined. The adjusted quantization parameter mbQP′ may be based on an initialized quantization parameter and a saliency score for a macroblock. In one embodiment, the adjusted quantization parameter mbQP′ may be based on a difference between a salience score for a macroblock and the average salience value. For example, mbQP′ may be determined according to the following formula:

$${mbQP}^{′} ( i , j ) = H ( mbQP ( i , j ) * ( 1 - α \frac{SMap ( i , j ) - AveSaliency}{AveSaliency} ) )$$

where mbQP(i,j) may represent an initialized quantization parameter for macroblock (i,j), Smap(i.j) may represent the saliency score for the macroblock (i,j), and mbQP′(i,j) may represent the adjusted quantization parameter for the macroblock (i.j). Moreover, HO may represent a rectification function assuring the quantization parameter mbQP′ is bound within a particular range of acceptable quantization parameter values. In some embodiments, the range may be determined in accordance with one or more coding standards, such as H.264, and/or may be dynamically adjusted based on the video signal. α may represent a salience control parameter that may be static or dynamic, determined by a user, and/or based on the video signal. In embodiments in which α is dynamic and/or based on the video signal, a may be determined based, at least in part, on image statistics, video quality requirements, and/or subjective video assessment. In at least one embodiment, a may be fixed at 0.5.

Embodiments described herein are directed to improving video quality by adjusting a quantization parameter for one or more macroblocks of a picture. However, embodiments described herein may be directed to other applications as well. For example, in at least one embodiment, saliency scores may be used to adjust deadzone control strength, forward quantization matrices, quantization rounding offset, and/or any combination thereof. Adjustments made in this manner may be used to control bit allocation at any coding unit level, such as at a picture (frame or field) level.

In another example, saliency scores may be used to adjust and/or bias rate-distortion processes. Trellis optimization processes, mode decisions, and/or picture-adaptive frame-field (PAFF) coding decisions, for instance, may use saliency scores to adjust costs associated with these encoding techniques. In at least one embodiment, for example, a high saliency score for a macroblock may result in use of more bits for the macroblock and/or a frame including the macroblock and a low saliency score for a macroblock may result in use of fewer bits for the macroblock and/or a frame including the macroblock.

As described, saliency scores may be provided in response to identifying video content elements at the macroblock level, however, it will be appreciated that video content elements may be identified to provide saliency scores for other coding unit levels as well. Accordingly, in yet another example, saliency scores may be used by a QP controller, such as the QP controller 250 of FIG. 2, to balance bit allocation among other types coding units, such as slices or pictures. This may, for instance, result in more temporally consistent video content. In one embodiment, saliency scores may be used at multiple coding unit levels simultaneously. For example, saliency scores may be used to simultaneously allocate bits between macroblocks of a single frame as well as between frames of a single group of pictures for a same video signal.

Saliency scores may further be used to adjust allocation of bits between sources of a broadcast channel. For example, a statistical multiplexer (not shown) may utilize saliency scores to allocate bits between sources of a broadcast channel such that sources having higher saliency scores may be allocated more bits and therefore more bandwidth of the channel. Sources having lower saliency scores may be allocated fewer bits to compensate for the increased rates of the high saliency score sources such that a bit rate is maintained, and/or the rate of the bit stream may be increased to compensate.

FIG. 6 is a schematic illustration of a media delivery system 600 in accordance with embodiments of the present invention. The media delivery system 600 may provide a mechanism for delivering a media source 602 to one or more of a variety of media output(s) 604. Although only one media source 602 and media output 604 are illustrated in FIG. 6, it is to be understood that any number may be used, and examples of the present invention may be used to broadcast and/or otherwise deliver media content to any number of media outputs.

The media source data 602 may be any source of media content, including but not limited to, video, audio, data, or combinations thereof. The media source data 602 may be, for example, audio and/or video data that may be captured using a camera, microphone, and/or other capturing devices, or may be generated or provided by a processing device. Media source data 602 may be analog or digital. When the media source data 602 is analog data, the media source data 602 may be converted to digital data using, for example, an analog-to-digital converter (ADC). Typically, to transmit the media source data 602, some type of compression and/or encryption may be desirable. Accordingly, an encoder 610 may be provided that may encode the media source data 602 using any encoding method in the art, known now or in the future, including encoding methods in accordance with video standards such as, but not limited to, MPEG-2, MPEG-4, H.264, H.HEVC, or combinations of these or other encoding standards. The encoder 610 may be implemented using any encoder described herein, including the encoder 100 of FIG. 1.

The encoded data 612 may be provided to a communications link, such as a satellite 614, an antenna 616, and/or a network 618. The network 618 may be wired or wireless, and further may communicate using electrical and/or optical transmission. The antenna 616 may be a terrestrial antenna, and may, for example, receive and transmit conventional AM and FM signals, satellite signals, or other signals known in the art. The communications link may broadcast the encoded data 612, and in some examples may alter the encoded data 612 and broadcast the altered encoded data 612 (e.g. by re-encoding, adding to, or subtracting from the encoded data 612). The encoded data 620 provided from the communications link may be received by a receiver 622 that may include or be coupled to a decoder. The decoder may decode the encoded data 620 to provide one or more media outputs, with the media output 604 shown in FIG. 6.

The receiver 622 may be included in or in communication with any number of devices, including but not limited to a modem, router, server, set-top box, laptop, desktop, computer, tablet, mobile phone, etc.

The media delivery system 600 of FIG. 6 and/or the encoder 610 may be utilized in a variety of segments of a content distribution industry.

FIG. 7 is a schematic illustration of a video distribution system that 700 may make use of encoders described herein. The video distribution system 700 includes video contributors 705. The video contributors 705 may include, but are not limited to, digital satellite news gathering systems 706, event broadcasts 707, and remote studios 708. Each or any of these video contributors 705 may utilize an encoder described herein, such as the encoder 610 of FIG. 6, to encode media source data and provide encoded data to a communications link. The digital satellite news gathering system 706 may provide encoded data to a satellite 702 The event broadcast 707 may provide encoded data to an antenna 701. The remote studio 708 may provide encoded data over a network 703.

A production segment 710 may include a content originator 712. The content originator 712 may receive encoded data from any or combinations of the video contributors 705. The content originator 712 may make the received content available, and may edit, combine, and/or manipulate any of the received content to make the content available. The content originator 712 may utilize encoders described herein, such as the encoder 610 of FIG. 6, to provide encoded data to the satellite 714 (or another communications link). The content originator 712 may provide encoded data to a digital terrestrial television system 716 over a network or other communication link. In some examples, the content originator 712 may utilize a decoder to decode the content received from the contributor(s) 705. The content originator 712 may then re-encode data and provide the encoded data to the satellite 714. In other examples, the content originator 712 may not decode the received data, and may utilize a transcoder to change an encoding format of the received data.

A primary distribution segment 720 may include a digital broadcast system 721, the digital terrestrial television system 716, and/or a cable system 723. The digital broadcasting system 721 may include a receiver, such as the receiver 622 described with reference to FIG. 6, to receive encoded data from the satellite 714. The digital terrestrial television system 716 may include a receiver, such as the receiver 622 described with reference to FIG. 6, to receive encoded data from the content originator 712. The cable system 723 may host its own content which may or may not have been received from the production segment 710 and/or the contributor segment 705. For example, the cable system 723 may provide its own media source data 602 as that which was described with reference to FIG. 6.

The digital broadcast system 721 may include an encoder, such as the encoder 610 described with reference to FIG. 6, to provide encoded data to the satellite 725. The cable system 723 may include an encoder, such as the encoder 610 described with reference to FIG. 6, to provide encoded data over a network or other communications link to a cable local headend 732. A secondary distribution segment 730 may include, for example, the satellite 725 and/or the cable local headend 732.

The cable local headend 732 may include an encoder, such as the encoder 610 described with reference to FIG. 6, to provide encoded data to clients in a client segment 640 over a network or other communications link. The satellite 725 may broadcast signals to clients in the client segment 740. The client segment 740 may include any number of devices that may include receivers, such as the receiver 622 and associated decoder described with reference to FIG. 6, for decoding content, and ultimately, making content available to users. The client segment 740 may include devices such as set-top boxes, tablets, computers, servers, laptops, desktops, cell phones, etc.

Accordingly, encoding, transcoding, and/or decoding may be utilized at any of a number of points in a video distribution system. Embodiments of the present invention may find use within any, or in some examples all, of these segments.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. An apparatus, comprising:
an encoder configured to receive a video signal and to generate a saliency score for a macroblock of the video signal, the encoder further configured to adjust a quantization parameter for the macroblock of the video signal based, at least in part, on the respective saliency score for the macroblock of the video signal.

2. The apparatus of claim 1, wherein the encoder is configured to operate in accordance with the MPEG-2 coding standard, the H.264 coding standard, the H.265 coding standard, the HEVC coding standard, or a combination thereof.

3. The apparatus of claim 1, wherein the encoder comprises:
a quantization controller configured to adjust the quantization parameter for the macroblock of the video signal to generate an adjusted quantization parameter for the macroblock of the video signal; and
a quantization block configured to quantize a coefficient block for the macroblock of the video signal in accordance with the adjusted quantization parameter.

4. The apparatus of claim 3, wherein the quantization controller is included in a mode decision block.

5. The apparatus of claim 1, wherein the saliency score is based, at least in part, on the identification of a video content element in the video signal.

6. The apparatus of claim 5, wherein the video content element comprises luminance component activity, chrominance component activity, a sum of absolute differences of a luminance component, a sum of absolute differences of a chrominance component, luminance component mean value, chrominance component mean value, luminance component pixel variation, chrominance component pixel variation, skin tone strength, or a combination thereof, wherein the video content element is determined at a frame, macroblock or sub-block level.

7. An encoder, comprising:
a quantization controller configured to receive a video signal and to determine a magnitude of a video content elements included in a macroblock, the quantization controller further configured to adjust a quantization parameter corresponding to the macroblock based, at least in part, on the magnitude of the video content element.

8. The encoder of claim 7, wherein the encoder comprises:
a quantization block configured to receive the adjusted quantization parameter and to quantize a coefficient block according to the adjusted quantization parameter.

9. The encoder of claim 7, further comprising:
an entropy encoder configured to encode one or more residuals to provide an encoded bitstream.

10. The encoder of claim 7, wherein the quantization controller comprises:
a saliency detection block configured to receive the video signal and generate a saliency score for the macroblock based, at least in part, on the magnitude of the video content element; and
a quantization parameter adjustment block coupled to the saliency detection block and configured to receive the saliency score and an initial quantization parameter, the quantization parameter adjustment block further configured to adjust the initial quantization parameter to generate the adjusted quantization parameter based, at least in part, on the saliency score.

11. The encoder of claim 10, wherein the saliency score comprises a value of an index of a saliency map.

12. The encoder of claim 10, wherein the initial quantization parameter is based, at least in part, on an estimated frame size.

13. A method, comprising:
generating, with an encoder, a saliency score based, at least in part, on a magnitude of a video content element included in a macroblock of a video signal; and
adjusting a quantization parameter based, at least in part, on the saliency score to provide an adjusted quantization parameter.

14. The method of claim 13, wherein said adjusting the quantization parameter comprises:
determining the difference between the saliency score and an average saliency value of a saliency map.

15. The method of claim 13, wherein said generating a saliency score comprises:
generating a feature map based, at least in part, on the magnitude of the video content element included in the macroblock;
generating a histogram based, at least in part, on the feature map;
generating a count map based, at least in part, on the histogram; and
generating a saliency map based, at least in part, on the count map.

16. The method of claim 13, wherein the encoder is configured to operate in accordance with the MPEG-2 coding standard, the H.264 coding standard, the H.265 coding standard, the HEVC coding standard, or a combination thereof.

17. The method of claim 13, further comprising:
performing a rectification function on the adjusted quantization parameter.

18. The method of claim 13, further comprising:
quantizing a coefficient block corresponding to the macroblock in accordance with the adjusted quantization parameter.

19. The method of claim 13, further comprising:
adjusting the number of bits allocated to a video source in accordance with the adjusted quantization parameter.

20. The method of claim 13, wherein the video content element comprises luminance component activity, chrominance component activity, a sum of absolute differences of a luminance component, a sum of absolute differences of a chrominance component, luminance component mean value, chrominance component mean value, luminance component pixel variation, chrominance component pixel variation, skin tone strength, or a combination thereof, wherein the video content element is determined at a frame, macroblock or sub-block level.
